(19) United States
(12) Patent Application Publication
(10) Pub. No.: US 2004/0079125 A1
(43) Pub. Date: Apr. 29, 2004

(54) Magnetic key

(76) Inventors: Gary E. Morehart, Rocky Mount, NC (US); Samuel Todd Adams, Winterville, NC (US)

Correspondence Address: DENNIS A. GROSS, D|B|A THE HILL FIRM, 666 DUNDEE RD, SUITE 1201, NORTHBROOK, IL, 60062, US

(21) Appl. No.: 10/282,416

(22) Filed: Oct. 29, 2002

(51) Int. Cl. E05B 19/04; E05B 19/26; E05B 47/00

(52) U.S. Cl. 70/408; 70/413

(57) ABSTRACT

A key blank is provided with an enlarged head end encased in plastics material and enclosing a permanent magnet received in an opening through the key head and retained in an intermediate grommet holder, the magnet having a sufficient strength to attach the key removably to ferrous surface.

### BACKGROUND OF THE INVENTION

1. Field of the Invention

This invention relates to keys for locks and more particularly to an encapsulated head key having a magnet imbedded a molded encapsulating head.

2. Background of the Invention

Standard keys for locks, including tumbler locks, generally consist of an enlarged head portion and a projecting shank portion which may be provided with appropriate lock mating profiles and a bitted edge. Such keys, although known to be made from various materials including steel, brass, bronze, alloys, plastic, etc. are generally not manufactured of magnetic material since the magnetic field would potentially interfere with use of the key.

Key heads are normally provided with an opening or punch-out area for attachment to key rings or other holders, and in this manner the keys may be placed in a display such as a key rack or the like.

Recently it has become common to encase the head of the key in a relatively larger, thicker plastic body which may be molded in place around the key head. Such encased keys may both facilitate recognition and handling of the key and further provide an area for molding in place other key related components such as, for example, transponder components as shown in U.S. Pat. No. 5,974,844. It is standard, when encasing key heads to provide openings through the encased head for attachment to key chains, key rings, key holders, etc. Existing key holders generally require the provision of a physical structure or mechanical device such as a hook or chain for attachment to the key to any other structure and thus the positioning of the key with respect to the key holder is limited.

It would be an advance in the art to be able to use magnetic attraction to attach a key to any ferrous surface in any position on the surface. Due, however, to the use of non-magnetic materials for the manufacture of the key, and the desire to not introduce a magnetized key into a lock where the magnetic strength of the key might interfere with the functioning of the lock, external magnets would have to be attached to the key. Such external magnets would again then require a holder or connector of some sort to attach them to the key either by adhesive, clamping on or the like. It would therefore be an advance in the art to provide a key having permanent magnet features where the magnet is a part of the key, not a separate attachment and where the portions of the key operating the lock are not magnetized.

### SUMMARY OF THE INVENTION

The present invention satisfies the foresaid need by providing a key blank formed of non-ferrous material having an enlarged head formed with an opening therethrough, the opening receiving a holder which in turn carries a permanent magnet. The key head, after insertion of the magnet carrying holder into the head opening is encased in plastic such that the magnet is entirely imbedded in the plastic molded head.

In a preferred embodiment a key is provided with a key head and the projecting blade, an opening through the head, a permanent magnet situated in the opening and the head and the magnet are encapsulated in plastic.

In an embodiment of the invention a metallic non-ferrous key blank is provided with a key head with a projecting blade, the key head being provided with an opening therethrough receiving a holder containing a magnet, the key head, holder and magnet being encapsulated in plastic.

### BRIEF DESCRIPTION OF THE DRAWINGS

In the drawings:

FIG. 1 illustrates an encapsulated head key.

FIG. 2 shows the key of FIG. 1 without the plastic head in capsulation.

FIG. 3 is a perspective view of the key of FIG. 2.

FIG. 4 is a key blank prior to attachment of the magnet.

FIG. 5 is a perspective view of a grommet for holding a magnet.

FIG. 6 is a view of a permanent magnet button suitable for use.

### DETAILED DESCRIPTION OF THE PRESENTLY PREFERRED EMBODIMENT

As illustrated in the Figures, a key 10 consists of a blank 1 having a key head 3 from which projects a shank or blade portion 4 grooved for a lock and having an edge which may be bitted to operate a tumbler-pin combination. Although such key heads are normally provided with an opening 11 through which a key chain or other key holder may be passed, according to this invention the key head 3 is provided with larger opening 2 which will receive a permanent magnet 8 whereby the key may be affixed to any ferrous surface. The permanent magnet 8 preferably has a gauss strength sufficient to removably attach key to a ferrous surface even after the key head has been encapsulated in a plastic coating 15. Preferably the key blank is non-ferrous such that the key blade 4 will not experience any magnetic attraction as a result of the presence of the magnet 8 in the opening 2 in the head.

A preferred magnetic material is neodymium. In order to facilitate the positioning of the magnetic disc 8 in the opening 2 in the key head 3, a holder or grommet 5 having a central opening 7 dimensioned to receive the magnet 8 and may be utilized. As is shown the holder 5 may be premolded and may include an external groove 16 dimensioned to be received in the inner diameter of the opening 2 so that the grommet is firmly fixed in place. The grommet may have an opening 7 dimensioned for a press fit relation with the magnet. Alternatively if the grommet is formed of a resilient material the grommet itself may be provided with an inner diameter groove for receipt of the magnet. Finally, the grommet may, instead of being provided with a groove 16 having flanges at both axial ends of the groove, be provided with a normal outer diameter surface extending to one axial end with an enlarged O.D. at the other axial end forming a ledge. The grommet can be inserted in the key opening from one side of the key with the ledger shoulder at the other end of the outer diameter groove abutting one face of the key head.

The holder, or grommet, 5 may be molded independently of the key and then inserted into the hole or, alternatively, may be molded in place in the hole 2. Although the hole 2 has been shown as being round, it may be shaped differently or it may be provided with an edge configuration which will mate with a corresponding edge configuration or shape on the grommet to prevent rotation or movement of the grommet within the opening.

As shown in FIG. 3 a first subassembly 6 with the grommet either inserted into the opening or molded in place of the opening may advantageously utilize a grommet (or holder) having a thickness greater than the thickness of the key head 3 whereby a magnet 8 may be utilized which also has a thickness greater than the key head. By providing a holder capable of securing a magnet thicker than the key head itself, the dimensions of the magnet may be chosen to provide the appropriate gauss strength without making the opening 2 undesirably large. Although FIG. 3 shows the holder as being circular, it obviously can be formed in other shapes to accommodate different sized and shaped magnets.

FIG. 2 shows a final subassembly prior to encapsulation with a magnet 8 received in place in the holder.

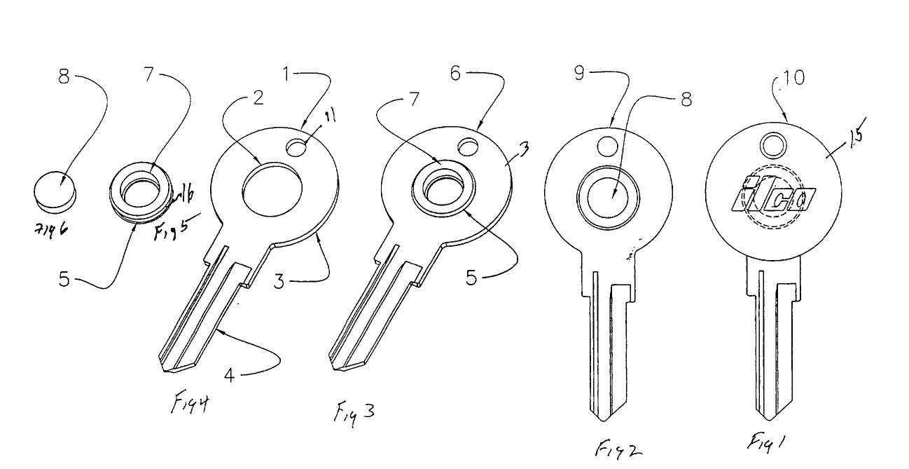

FIG. 1 illustrates the key after encapsulation. The actual molding of the encapsulating head is standard in the art and is widely used.

Once the holder 7 and magnet 8 are encapsulated within the key head, the magnet is protected from damage or loss while at the same time being properly positioned to allow the head of the key to be attached to any ferrous surface. The degree of strength of the attachment is determined by the strength of the magnetic field and can range from a strength allowing easy removability from the ferrous object to a much stronger attraction so that the key may be attached to surfaces that may undergo jarring, bumping or vibration without the key becoming dislodged but which will still allow intentional removal.

It will be appreciated that this invention provides a magnetic key which utilizes a key blank having a head with an opening therethrough, a magnet received in the opening and the head and magnet being encapsulated in a non-magnetic cover molded in place.

I claim as my invention:

1. A key comprising a key blank having a head with a projecting blade, an opening through the head, a permanent magnet received in the opening, the head and magnet being encapsulated in a molded plastics material.

2. A key according to claim 1 wherein a holder is interposed between the key head and the magnet, the head, holder and magnet being encapsulated.

3. A key according to claim 2 wherein the holder is molded in place in the opening in the key head which in turn has an opening shaped to receive the magnet.

4. A key according to claim 2 wherein the holder is formed separately of the key head and is assembled to the key head in the opening prior to insertion of a magnet into a recess in the holder.

5. A magnetic key comprising a non-ferrous key blank having a head and a projecting blade, the head having an opening therein, the opening receiving a holder, the holder carrying a permanent magnet, and at least portions of the head including the holder and permanent magnet encapsulated in plastic.

6. A key according to claim 5 wherein the holder is thicker than the thickness of the key head and projects from both surfaces of the key head.

7. A key according to claim 6 wherein the magnet is thicker than the thickness of the key head and projects form at least one surface of the key head.

8. A key according to claim 7 wherein the magnet has a strength sufficient to attach the key to a ferrous surface and to hold it at such surface until it intentionally removed.
